(19) United States
(12) Patent Application Publication
(10) Pub. No.: US 2009/0249276 A1
(43) Pub. Date: Oct. 1, 2009

(54) METHODS AND SYSTEMS FOR FPGA REWIRING AND ROUTING IN EDA DESIGNS

(75) Inventors: Yu-Liang Wu, Shatin (CN); Wai Chung Tang, Tsuen Wan (CN); Lin Zhou, Shatin (CN); Wing Hang Lo, Kowloon (CN)

Correspondence Address: SEED INTELLECTUAL PROPERTY LAW GROUP PLLC, 701 FIFTH AVE, SUITE 5400, SEATTLE, WA, 98104, US

(73) Assignee: THE CHINESE UNIVERSITY OF HONG KONG, Shatin (CN)

(21) Appl. No.: 12/392,006

(22) Filed: Feb. 24, 2009

Related U.S. Application Data
(60) Provisional application No. 61/031,268, filed on Feb. 25, 2008.

(51) Int. Cl. G06F 17/50

(52) U.S. Cl. 716/16

(57) ABSTRACT

Disclosed are a method and a system for improving FPGA routings of a circuit. The method comprises: identifying candidate alternative wires for a target wire to be replaced in the circuit according to a first preset rule; selecting a first set of alternative wires from the identified candidates according to a second preset rule; filtering the selected first set of candidates so as to reserve a second set of candidates; estimating wire replacing costs of the second set of candidates to select a third set of candidates that can improve FPGA delay performance of the circuit; and replacing the target wire with the selected third set of candidate alternative wires.

### FIELD OF THE INVENTION

The present application relates to a Field Programmable Gate Array (FPGA) rewiring and routing technique in EDA Designs.

### BACKGROUND OF THE INVENTION

In most conventional EDA physical design tools, a logic synthesis based optimization technique is not applicable due to the missing of logic view information. The problem becomes even harder for today's crucial routing performance problems as most logic synthesis techniques are more cell-conscious oriented instead of wiring-aware oriented, while the wiring-aware oriented logic synthesis techniques are more suitable for wiring-crucial synthesis purposes.

Rewiring is a technique that replaces a wire/gate with other wires/gates without changing the logic function of a circuit, which can also be considered as an effective bridge for binding the originally loose gap between logic view and physical view of implemented circuits. Currently, best-known rewiring techniques can be classified into three groups: the Automatic Test Pattern Generation (ATPG) based rewiring method, the Set of Pairs of Functions to be Distinguished (SPFD) based method and the Graph-Based Alternative Wiring (GBAW) method.

The first work applying the ATPG-based rewiring techniques for FPGA routability improvement is proposed in “Postlayout logic restructuring using alternative wires” of S. C. Chang, K. T. Cheng, N. S. Woo, and M. Marek-Sadowska, IEEE Trans. Computer-aided Design, vol. 16, pp. 587-596, June, 1997. In this work, rewiring is used to find alternative wires for all nets after placement. Accordingly, routing order priorities are assigned to the nets using a simple rule: lower routing priorities are assigned to nets with alternative wires, and higher priorities are assigned to nets without alternative wires. If a net could not be routed, it would be replaced by its alternative wire. This priority ranking idea is roughly sound as a wire possessing more alternative wires can be considered to have more routing flexibility and thus can yield more alternatives in later routing stages where routing resources are less abundant. In that paper, experiments are carried out on two circuits by using an AT&T ORCA router. These two originally but not completely routed circuits are successfully routed under this scheme. This is the first known work in the art to apply rewiring to improve a FPGA routing. However, as the circuit structure will change after each rewiring, the ranking may be out-dated after any rewiring transformation, and the special properties of Look-Up-Table (LUT) based structures are not explored much in this routing scheme, either.

Another approach is SPFD-based postlayout logic synthesis. Its delay reduction scheme, SPFD-based Enhanced Rewiring (ER) technique, is presented in “A new enhanced SPFD rewiring algorithm” of J. Cong, J. Y Lin, and W. N. Long, in Proc. IEEE/ACM International Conference on Computer-aided Design '02, San Jose, Calif., USA, November 2002, pp. 672-678. In this work, based on placement information, a delay model is used to estimate delays of all nets. This model is based on locations of LUTs in Quartus placement, and the delay between different locations in the Quartus placement is statistically calculated. The delay between two LUTs is estimated as an average delay between these two locations. The SPFD-based rewiring scheme traverses the circuit for M passes to perform rewiring on ε-critical paths. An ε-critical path is a path whose delay is larger than (1−ε)D, where D is the largest path delay and ε<1. After a replacement, the placement is not redone and only routing is performed for a whole new netlist. In experiments, Quartus (Version II 1.0) is applied to do the placement and routing. The application of SPFD-based rewiring brings a reduction of up to 22.3% (avg. 5.1%) on critical path delay, whereas two of eleven benchmark circuits become worse on delay performance. The approach suffers in a quite slow runtime. According to the experiments, the placement and routing for some circuits are not completed within 8 hours due to their CPU-costly equivalence condition test for the rewiring. For other circuits, the runtime of ER is 12.5 times of that of the SPFD-based Local Rewiring (SPFD-LR) algorithm, whose average CPU time on the benchmark circuits is 52.5 seconds by the level-oriented method (up to 681.79 seconds), as stated in “A new method to express functional permissibilities for LUT based FPGAs and its applications” of S. Yamashita, H. Sawada, and A. Nagoya, in Proc. IEEE/ACM International Conference on Computer-aided Design '96, San Jose, Calif., USA, November 1996, pp. 254-261.

Following the work of ER, a SPFD-based One-to-Many Rewiring (OMR) method is proposed in “SPFD-based effective one-to-many rewiring (OMR) for delay reduction of LUT-based FPGA circuits,” of K Tanaka, S. Yamashita, and Y Kambayashi, in Proc. ACM Great Lake Sym. on VLSI '04, Boston, Mass., USA, April 2004, pp. 348-353, to improve the SPFD approach. The OMR performs rewiring by adding two or more wires to remove a target wire. According to comparison results of the CPU time and the number of target wires whose alternative wires are located, the OMR improves upon ER by 18% and 15% respectively. Unfortunately, this work does not show if this extra rewiring power is converted to a better routing performance, nor does it show the percentage of nets actually transformed to judge the efficiency of their rewiring transformations. In addition, neither LUT architectural particulars nor layout information is analyzed and used for rewiring selections on this work.

The basic idea of the ATPG-based rewiring techniques is to add a redundant wire/gate to make other wires/gates redundant and removable. A wire/gate is redundant if its addition or removal does not change the logic function of a Boolean network. A Boolean network can be modeled as a Directed Acyclic Graph (DAG), where each node corresponds to a Boolean functions and a Boolean variable yᵢ. If there is a path from node nᵢ to nⱼ, nᵢ is in the transitive fanin (TFI) of nⱼ, and nⱼ is in the transitive fanout (TFO) of nᵢ. The value of an input to a node is controlling if it determines the output value of the node; otherwise, it is noncontrolling or sensitizing. When a wire w is tested for a stuck-at fault 0(1), the faulty circuit is the circuit where w is replaced by a constant 0(1). An input combination is a test vector if the original circuit and the faulty circuit are different when it is applied. Mandatory assignments are the value assignments required for testing a certain fault, and they must be satisfied by all test vectors for that fault. The wire w is redundant if there is no test vector exists for its stuck-at fault.

FIG. 1 shows an example of ATPG-based rewiring working on a Boolean network. The example in FIG. 1 shows how ATPG-based rewiring works. First, a test is made to determine if G₃→G₇ is redundant and can be added. Stuck-at fault 1 (s-a-1) is tested at G₃→G₇, which requires G₃=0, thus {G₂=0, G₁=0, a=0, b=0, G₄=0}. To propagate the fault to a primary output, all side inputs to G₇ and G₉ should have noncontrolling values, so {f=1, g=0, G₆=1, G₄=1}. Because the value of G₄ cannot be consistently justified, s-a-1 at G₃→G₇ is undetectable, and G₃ G₇ is redundant. Therefore, the circuit is not changed after adding G₃→G₇. Second, a test is made to verify that though the addition of G₃→G₇ does not change the circuit function, it does, however, make the originally nonredundant wire G₁→G₅ redundant. To determine if G₁→G₅ is redundant, s-a-1 is tested at G₁→G₅, which requires {G₁=0, a=0, b=0}. To propagate the fault to a primary output, the side inputs to G₅, G₆, G₇, and G₉ should have noncontrolling values, thus {e=1, G₃=1, f=1, g=0, G₄=0, G₂=0, G₁=1}. The value of G₁ is not consistent now, which means that there is no test vector to make this fault detectable. Therefore, G₁→G₅ is redundant and removable.

Till now, most technology mapping techniques are targeted at reducing the number of LUTs and mapping depth, however, only at the network logic structure level without any knowledge of the actual layout information. Though a mapping depth optimized in a technology mapping step can be estimated as a rough objective for circuit delay reduction, this estimation can still deviate a lot from the reality after placement and routing. That is, a net (for example, L₁→L₂ as shown in FIG. 2 (b)) may have a long routing path in the FPGA, although its source is only one level away from its sink(s). For example, FIG. 2 (a) shows a Boolean network and its layout after placement and routing, where G₁→G₅ is a target wire and G₃→G₇ is its corresponding alternative wire. Though the rewiring transformation, i.e., wire replacing, does not change the number of LUTs and mapping depth, a net L₁→L₂ is replaced by a much shorter one L₄→L₅. Consequently, routing becomes easier, and circuit delay is reduced because the net passes through fewer switches. For simplicity, it is assumed that each Configurable Logic Block (LCB) includes one LUT, and LUT is used to represent both LUT and CLB throughout the context.

In view of the above, a layout-conscious rewiring method and a wiring-conscious transformation tool wisely binding the logical-physical gap in EDA flow would be useful and desired.

### SUMMARY OF THE INVENTION

In one aspect, there is disclosed a method for improving FPGA routings of a circuit, comprising:

identifying candidate alternative wires for a target wire to be replaced in the circuit according to a first preset rule;

selecting a first set of alternative wires from the identified alternative wires according to a second preset rule;

filtering the selected first set of alternative wires so as to reserve a second set of alternative wires;

estimating wire replacing costs of the second set of alternative wires to select a third set of alternative wires that can improve FPGA delay performance of the circuit; and

replacing the target wire with the selected third set of alternative wires.

In another aspect, there is disclosed a system for improving FPGA routings in a circuit, comprising:

an identifying unit configured to identify alternative wires for a target wire in the circuit according to a first preset rule;

a checking unit configured to check the identified alternative wires so as to select a first set of alternative wires from the candidate alternative wires according to a second preset rule;

a filtering unit configured to filter on the selected first set of alternative wires so as to reserve a second set of alternative wires;

an estimating unit configured to estimate wire replacing costs of the reserved second set of alternative wires to select a third set of candidate alternative wires that can improve FPGA delay performance of the circuit; and a replacing unit configured to place the target wire with the selected third set of alternative wires.

### BRIEF DESCRIPTION OF THE DRAWINGS

FIG. 1 shows an example of ATPG-based rewiring working on a Boolean network;

FIGS. 2(a) and 2(b) show an example of postlayout logic perturbation by ATPG-based rewiring;

FIG. 3 shows a traditional FPGA EDA flow in EDA Designs;

FIG. 4 shows a flow chart of the FPGA rewiring method according to an embodiment of the present application;

FIG. 5 shows an example of multiwire addition (K=5) in EDA Designs;

FIG. 6 shows an example of extra LUT addition (K=4) in EDA Designs;

FIG. 7 shows rules for identifying alternative candidates according to an embodiment of the present application;

FIG. 8 shows an example of an “existing” alternative wire (K=3)(Rule 2) according to an embodiment of the present application;

FIG. 9 shows an example of gate duplication in technology mapping (K=4) according to an embodiment of the present application;

FIG. 10 shows an example of destination LUT expansion (K=4) (Rule 4) according to an embodiment of the present application; and

FIG. 11 shows the work flow of the FPGA rewiring system according to an embodiment of the present application.

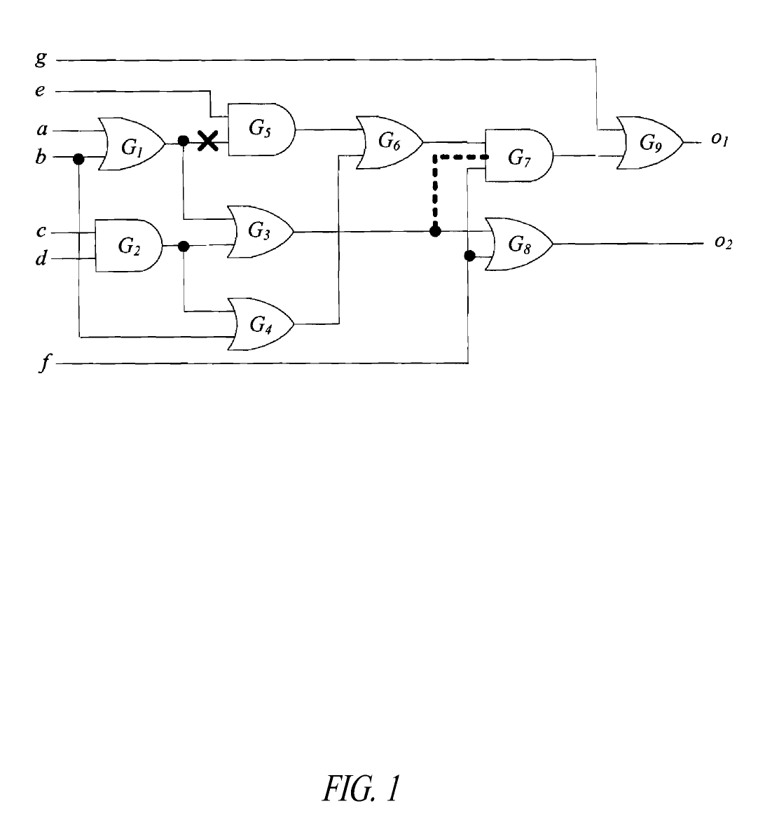

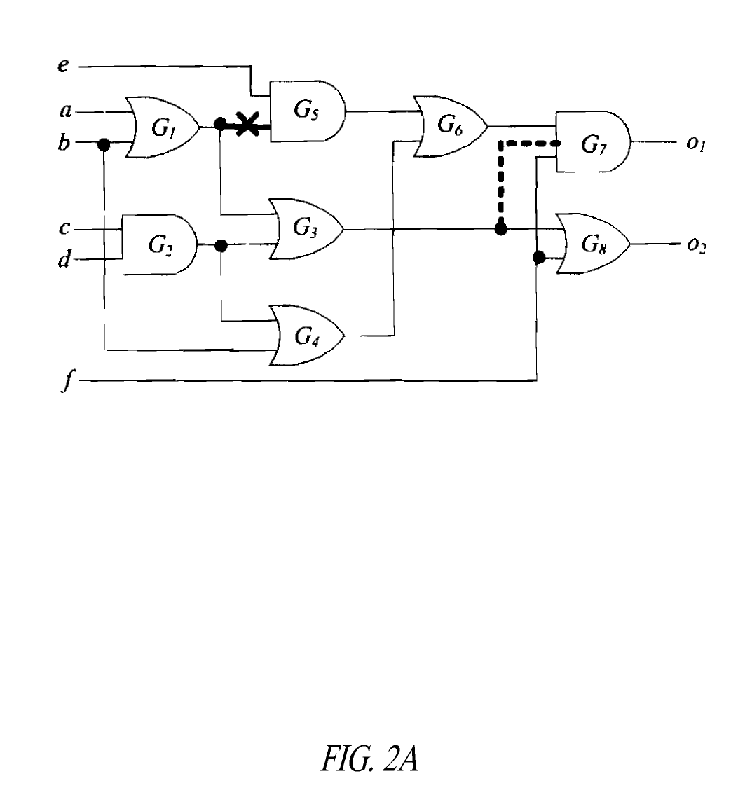

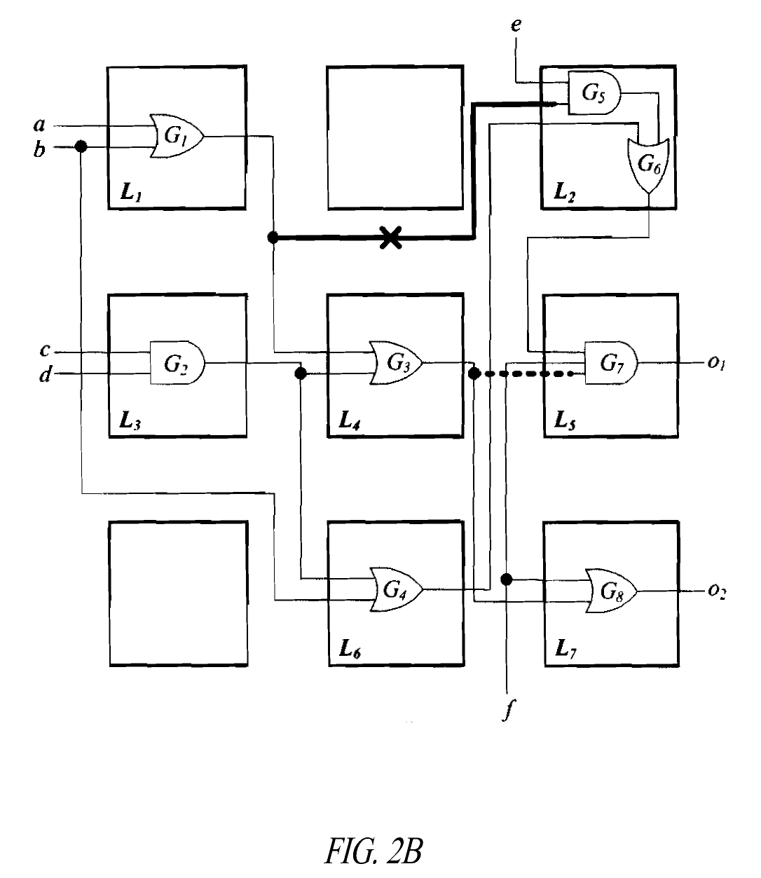

### DESCRIPTION OF THE PREFERRED EMBODIMENTS

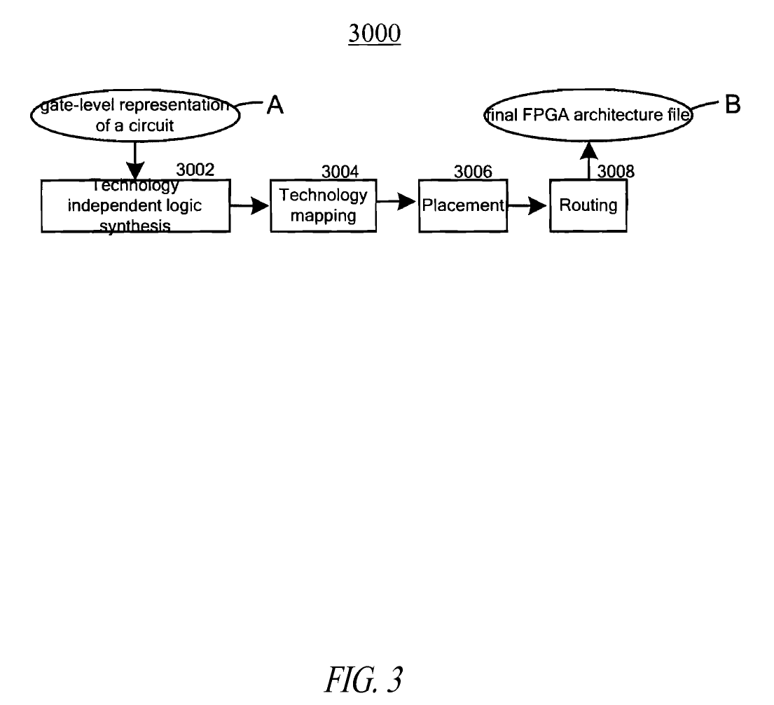

FIG. 3 shows a traditional FPGA EDA flow 3000 in EDA Designs. As shown in FIG. 3, at step 3002, a process of technology independent logic synthesis is performed on a circuit based on gate-level representation A of this circuit to generate a netlist of the circuit. At step 3004, logic gates of the circuit in the generated netlist are mapped into physical elements. Then, the mapped physical elements are placed and routed in steps 3006 and 3008, respectively, so as to obtain a final FPGA architecture file B.

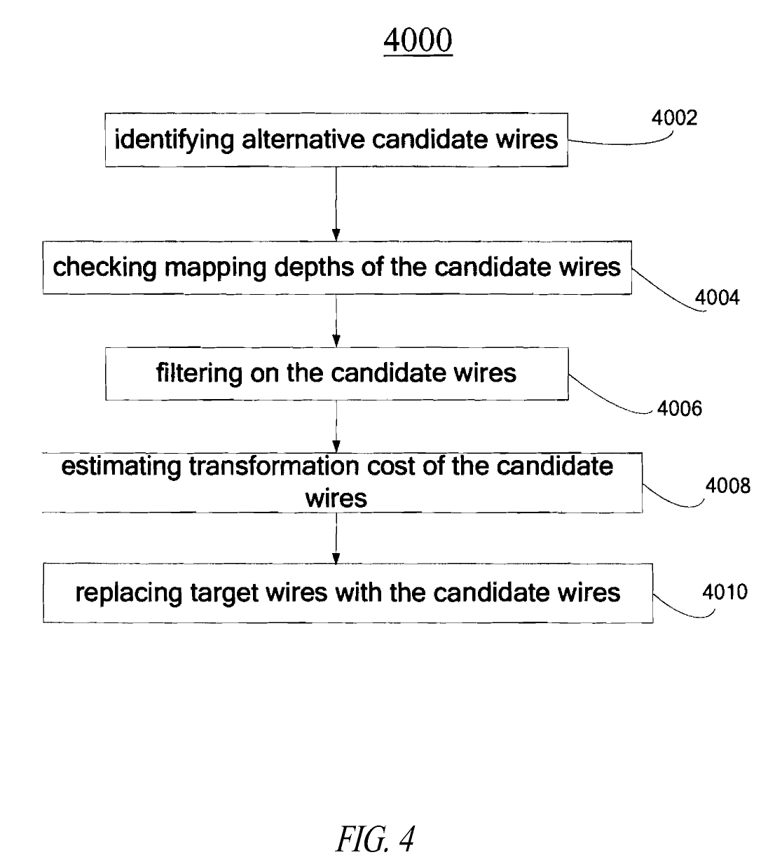

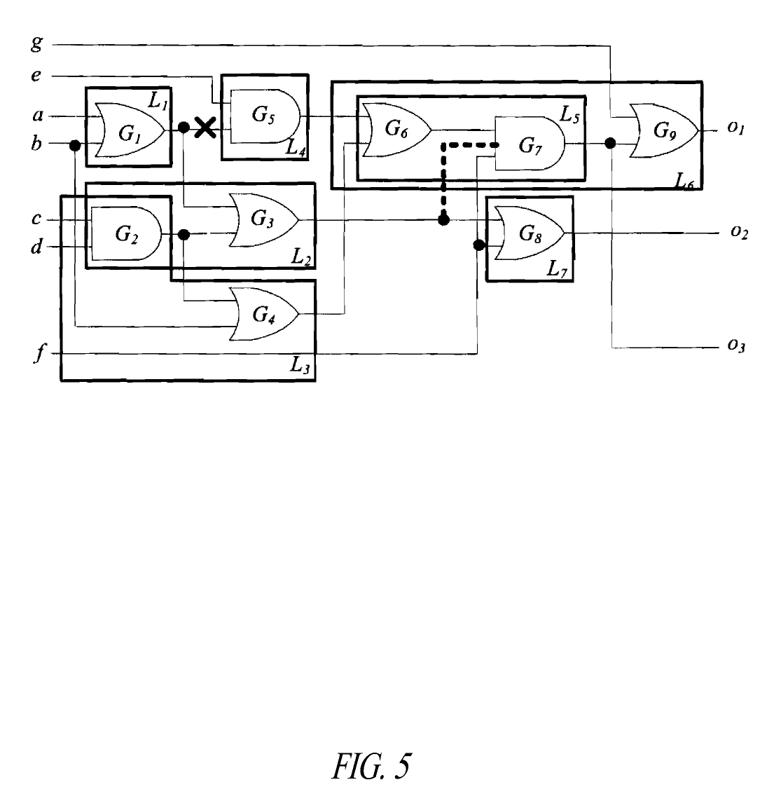

As seen from FIG. 3, logic information of a circuit is left aside after the step of technology mapping 3004. In order to facilitate the routing improvement process, a rewiring system is needed between a circuit's logic structure (gate-level representation) and its physical layout (LUT-level representation) for serving as an interface. In this case, a rewiring process 4000 as shown in FIG. 4 may be performed during the routing step 3008 on paths in the circuit, whose delays are larger than a predetermined value. Hereinafter, to distinguish the two representations of a circuit, the logic level representation is named as the subject circuit and the physical level representation is named as the mapped circuit. When rewiring is applied for postlayout logic perturbation, besides maintaining the circuit logic function, alternative candidates should: (1) have enough routing resources to use; and (2) do not require extra LUTs. Condition (1) is clearly due to the limitation of the LUT size. Condition (2) is to maintain the placement result, which will be explained later.

After technology mapping at step 3004, a wire in the subject circuit will become either internal (source gate and sink gate are in a same CLB) or external (source gate and sink gate are in different CLBs). The external wires form a netlist connecting CLBs. For efficiency, rewiring only for single-wire addition and removal is applied and described herein. However, it is obvious to those skilled in the art that multiwire addition and removal is also possible as the technology mapping forces some gates to be duplicated in several LUTs. For example, as shown in FIG. 5, G₃→G₇ is added to make G₁→G₅ redundant and removable. Thus, G₇ is duplicated in L₅ and L₆; so two wires, L₂→L₅ and L₂→L₆, are to be added for this transformation.

An FPGA rewiring process 4000 according to one embodiment of the present application is to be described below with reference to FIG. 4.

As shown in FIG. 4, the process 4000 begins at step 4002, in which candidate alternative wires for a target wire are identified without disturbing original placement of a circuit in an FPGA. At step 4004, mapping depths of the circuit when each of the identified alternative wires is added into the circuit are checked so that the alternative wires will not make the mapping depth to increase are accepted. At step 4006, the accepted alternative wires are filtered on and only those whose length satisfies a length constraint are reserved. The process 4000 estimates wire replacing costs of the reserved candidate alternative wires to select the alternative wires that can best improve FPGA delay performance at step 4008. Then, the target wire is replaced by the selected alternative wire at step 4010. Hereinafter, a detailed description will be given on each of the above steps.

A. Identiflcation of Alternative Candidates (step 4002)

Based on a structural relationship of subject circuits and mapped circuits, a set of rules are proposed to identify candidate alternative wires that can be applied for a wire replacement without disturbing the placement of the circuit. A series of strategies are used to select good candidates for transformations.

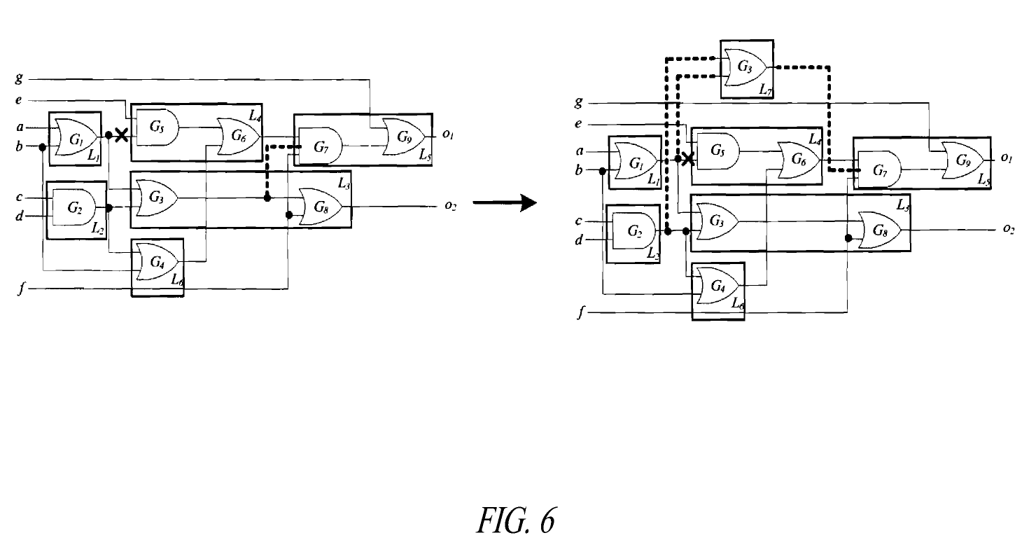

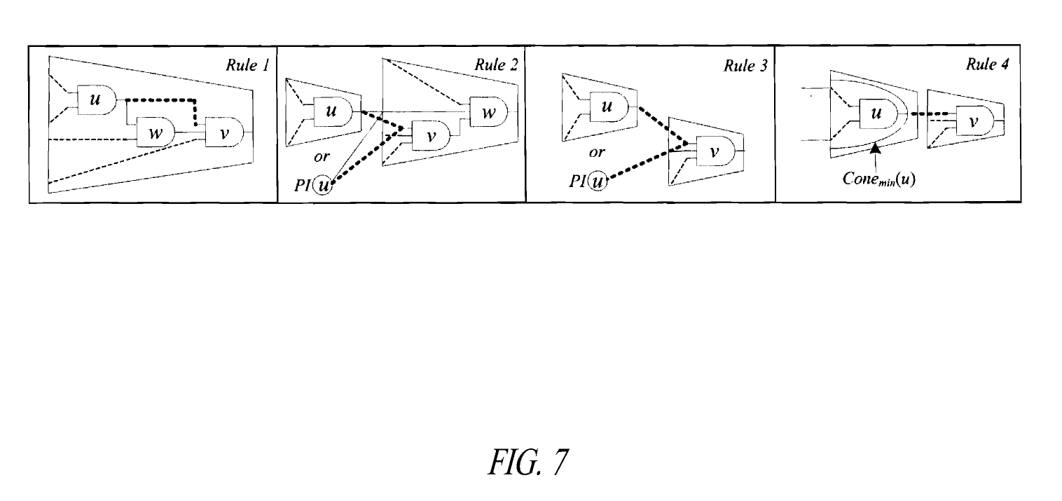

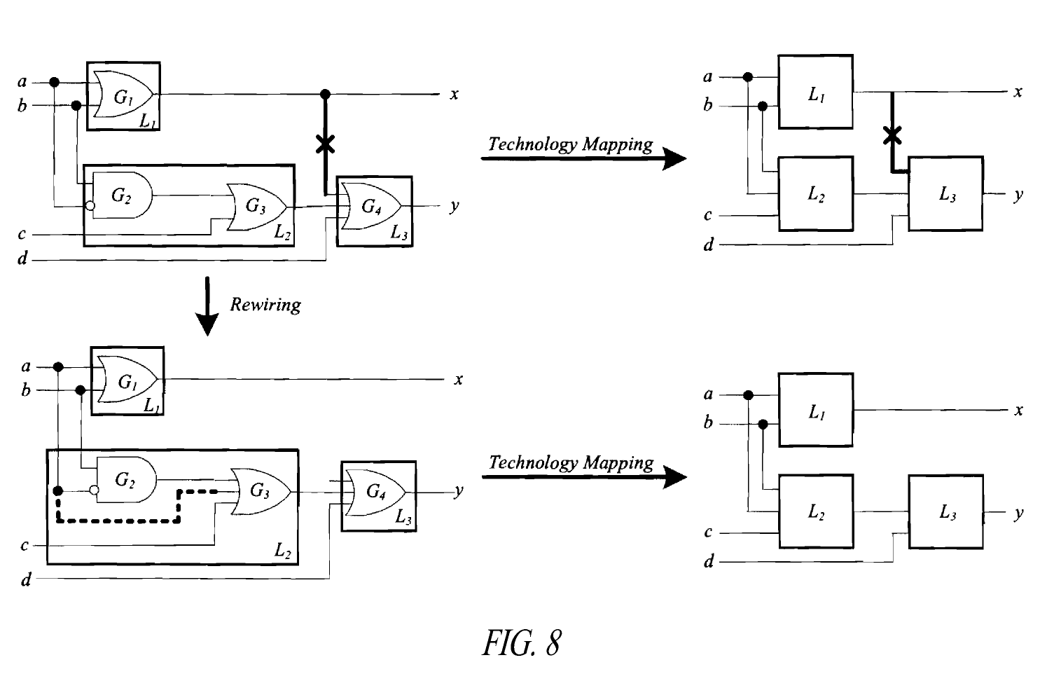

When an alternative wire is added to the mapped circuit, new LUTs may be required to maintain the logic equivalence. For example, as shown in FIG. 6, G₃ G₇ is added to replace G₁→G₅. However, as G₃ is not an output node (root) of L₃, a new LUT (L₇) with G₃ being the output node will be generated, which may not be feasible as there might be no available space for the added LUT. Below, a set of rules to identify the alternative wire u→v without causing extra LUTs will be illustrated with reference to FIG. 7.

Rule 1: u→v is internal. This rule is straight-forward. Only the logic mapping of the LUT containing that alternative wire needs to be updated.

Rule 2: u is a root of an LUT (or equivalently a primary input (PI)), and the LUT containing v has already taken u as an input. If this is the case, then clearly an internal wiring branching can be freely done by logic remapping of the LUT containing v. The example in FIG. 8 demonstrates this rule. As shown in FIG. 8, a→G₃ is added to replace G₁→G₄, whereas there has already been a wire a→L₂ connecting a and G₂. So, only the mapping of L₂ needs to be updated without adding extra LUTs or nets.

Rule 3: u is the root of an LUT (or equivalently a PI) but not an input of the LUT containing v, and the LUT containing v has an unused pin to connect u.

As a gate may be duplicated into several LUTs in a technology mapping, there can be more than one LUT containing v. Therefore, an application of Rule 2 or Rule 3 needs to assure that all related LUTs satisfy the requirements. Sometimes, several wires may need to be added into one LUT simultaneously (Rule 4), which requires the destination LUT to have enough free input pins for all new wires.

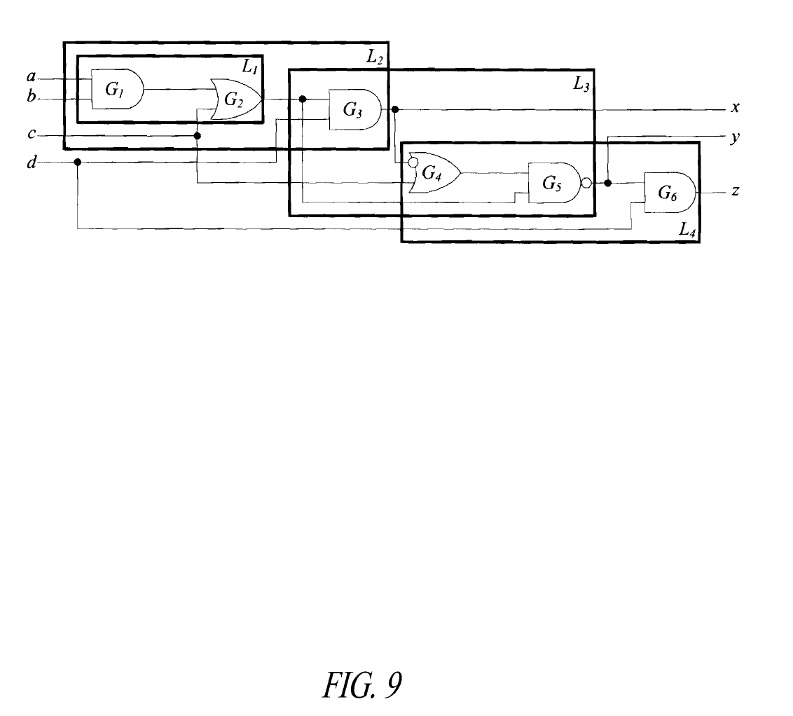

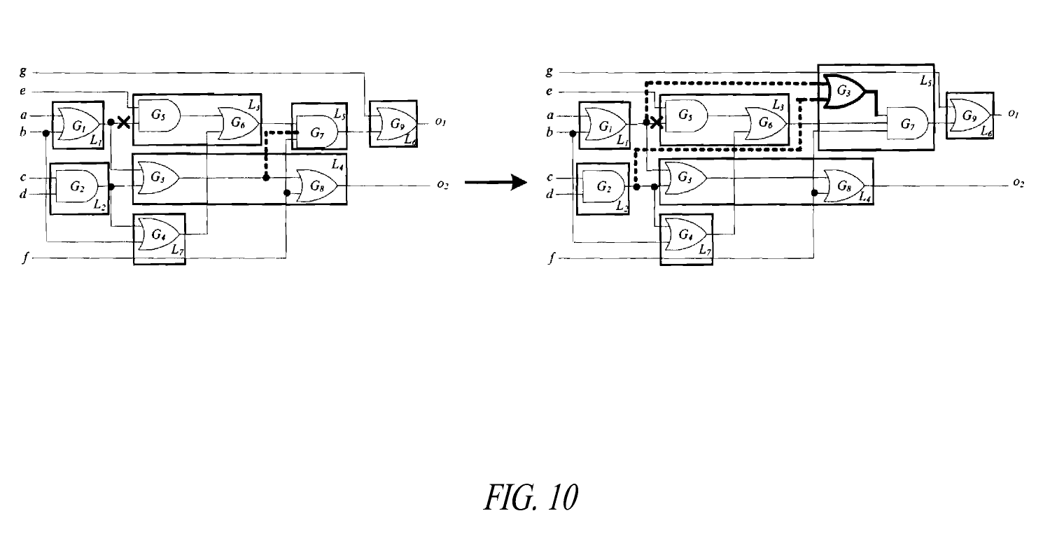

Rule 4: u is neither a PI nor a root of a LUT. Given that M₁ is an input set of u's TFI cone inside a LUT containing u, and M₂ is an input set of a LUT containing v, then |M₁+M₂|≦K, wherein k is maximum input pin number of a LUT. For example, in FIG. 9, the TFI cone of G₆ inside the LUT containing G₆ only covers G₄, G₅, and G₆. Given an alternative wire u→v, if |M₁+M₂|≦K, a whole logic producing u with the input set M₁ may be duplicated inside the LUT containing v. Thus, no extra LUT needs to be introduced. This process is called expansion. For example, as shown in FIG. 10, G₃→G₇ is to be added to make G₁→G₅ redundant and removable. Considering M₁={G₁, G₂}, M₂={G₆, f}, K=4, and |M₁+M₂|=K, L₅ then can be expanded by connecting M₁ (G₁ and G₂) to a duplicated logic G₃ inside L₅. Thus, a transformation is completed by updating the mapping of L₅ with a connection of two new wires without any LUT addition.

As shown in FIG. 9, after a technology mapping, some gates may be duplicated inside several LUTs, therefore a gate can have more than one TFI cone. Obviously, if this gate is the source node u of the alternative wire u→v, then choosing this gate's smallest related input set, the minimum TFI cone, might increase the chance of successfully expanding all LUTs containing v. For example, in FIG. 9, G₄ is duplicated in L₃ and L₄. Its TFI cone in L₃, Cone₃, contains G₃ and G₄ with input set {G₂, c, d}. Whereas the TFI cone of G₄ in L₄, Cone₄, only contains G₄ with input set {G₃, c} So the minimum TFI cone of G₄ is {G₃, c} When an alternative wire starting from G₄ is to be added, G₃ and c will be connected to all LUTs containing its sink node under Rule 4.

B. Mapping Depth Checking

When an identified alternative wire is added to the mapped circuit, the depth of the circuit should not increase to avoid increasing the critical path delay. Each LUT L is assigned a label label(L) which is equal to its topological order in the mapped circuit with primary inputs assigned a label 0. Thus the label of L is always larger than all its inputs' labels. That is, label(L₂)>label(L₁) if L₁ is an input of L₂. When an identified alternative wire L₁→L₂ is considered, it will be taken for wire replacement only when label(L₁)<label(L₂), and label(L₂) will keep its original label. According to the rewiring method of the present application, the label checking is performed to eliminate all candidates that may cause any node's label increase to assure that the mapping depth of any path is not increased after any rewiring. When several alternative wires are added to expand a destination LUT L₂, a maximum label IMAX may be obtained from all new input LUTs. If a condition l_{MAX}<label(L₂) is satisfied, the new wires will be accepted for wire replacement.

C. Filtering Candidate Alternative Wires

For one target wire, more than one feasible alternative wire may be found acceptable, according to the rewiring method of the present application. Then, the alternative wires are processed one by one and the first candidate whose length satisfies a length constraint set by equation (1) is selected. Herein, all lengths are measured using their Manhattan Distance with block spans being length units.

LEN(AW)≦LEN(TW)+α (1)

In equation (1), α is an integer specified by users and LEN(TW) represents the target net length. If a candidate's length, LEN(AW), is smaller than or equal to LEN(TW)+α, it will be accepted; otherwise, a measurement will be taken on the next candidate until an acceptable one is found, or this target wire is abandoned. In this equation, α is used to relax the length constraint on candidates. If α is too small, too many candidates will be filtered out including some effective ones. If α is too large, a much longer candidate will be selected, which might degrade the delay performance. Preferably, α=3 provides best results. Through keeping a mildly relaxing filtering the alternative wire lengths, a larger performance gain can be obtained by “breaking” the originally critical path delay via replacing some critical path wires by some, though might be longer, alternative wires located on non-critical paths.

D. Wiring Replacing Cost Estimation

A linear cost function is used to evaluate the chosen candidates. A candidate having a cost more than its target net will be discarded; otherwise, the transformation will be performed. Equation (2) is applied to judge how good the placement is for a given netlist.

$$Cost = {\sum }_{i = 1}^{{N}_{nets}} q ( i ) [ \frac{{bb}_{x} ( i )}{{{C}_{av , x} ( i )}^{β}} + \frac{{bb}_{y} ( i )}{{{C}_{av , y} ( i )}^{β}} ] \qquad ( 2 )$$

In equation (2), Nₙₑₜₛ is the total number of nets. bbₓ(i) and bb_{y}(i) denote horizontal and vertical spans of net i's bounding box, respectively. C_{av,x}(i) and C_{av,y}(i) indicate an average channel capacity in the horizontal and vertical directions over the bounding box of net i, respectively. β is used to adjust a relative cost of using narrow and wide channels. The larger the value of β is, the more wiring in narrow channels is penalized relative to wiring in wider channels. Preferably, β=1 results in highest quality placements. A parameter q(i) is used to approximate routing resource demands inside the bounding box and represents a net weight. Its value depends on the number of terminals on net i as Table I shows.

TABLE I
NUMBER OF TERMINALS VS. NET WEIGHT

| # of Terminals | Net weight q |
|---|---|
| 1-3 | 1.0000 |
| 4 | 1.0828 |
| 5 | 1.1536 |
| 6 | 1.2206 |
| 7 | 1.2823 |
| 8 | 1.3385 |
| 9 | 1.3991 |
| 10 | 1.4493 |
| 15 | 1.6899 |
| 20 | 1.8924 |
| 25 | 2.0743 |
| 30 | 2.2334 |
| 35 | 2.3895 |
| 40 | 2.5356 |
| 45 | 2.6625 |
| 50 | 2.7933 |

Suppose all channel capacities are the same and the numbers of terminals on all nets are equal, then the smaller each net's bounding box is, the lower the cost will be, and the better the placement will be. In this situation, it is the netlist that is to be changed. In a placement, the smaller the bounding box of a net is, the less cost it contributes. Based on this idea, given that all nets are two-pin nets and all channel capacities are equal, when a longer wire is replaced by a shorter one, the cost will be reduced, and the wire replacing can be performed. But in practice, most nets are multipin nets, and a removal or an addition of a subnet may not change the net's bounding box. Thus the cost change depends on q(i). Even though the bounding box size is different after a wire replacing, the cost change does not only depends on the bounding box but also on the parameter q(i). So given a net, one wire is selected from the alternative candidate set using equation (1), which is simply based on the bounding box computation of a single wire, and efficiency of the selected wire is evaluated using equation (2), which is more accurate in reflecting relation between the layout and the netlist structure.

E. Replacing a Target Wire with a Candidate Alternative Wire

After a candidate alternative wire with the best replacing cost is selected by using the above steps, the target wire is replaced by the selected alternative wire and an updated netlist of the circuit is generated.

After the process 4000 is done, a step of rerouting is performed on the updated netlist to obtain an improved final FPGA architecture file which contains logic information of the circuit.

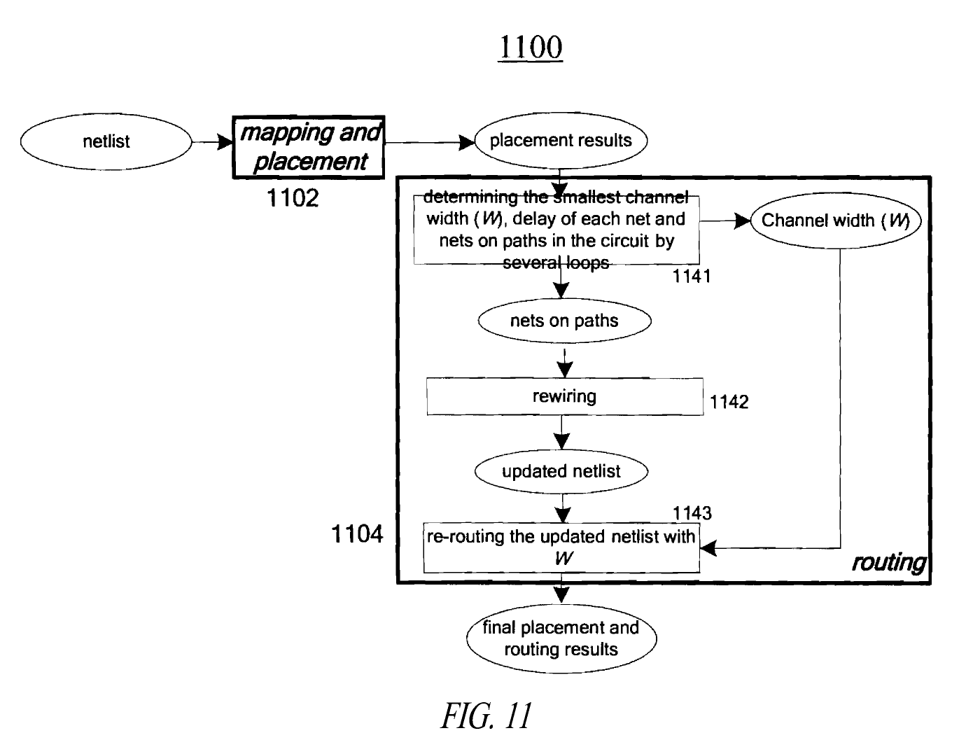

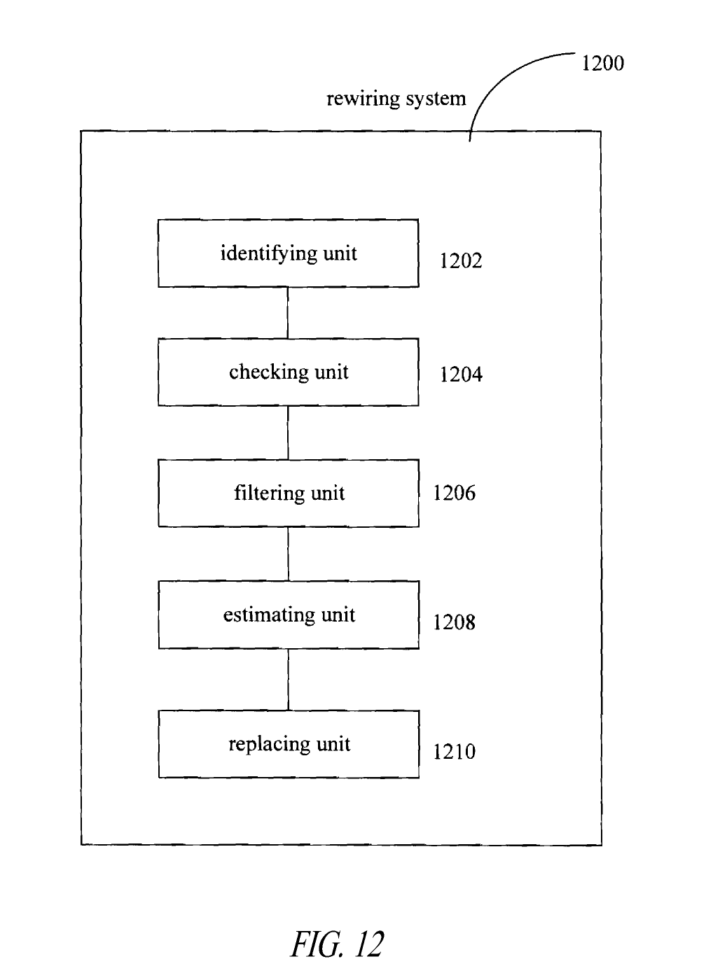

FIG. 11 shows a detailed work flow 1100 of the FPGA placement and routing using the rewiring method according to an embodiment of the present application. At first, technology mapping and placement are performed on a netlist of a circuit at step 1102 and placement results are thus generated. A routing process 1104 is then performed based on the placement results to generate final improved placement and routing results. The routing process 1104 in the embodiment of the present application further includes the following several steps. In step 1141, a channel width W, delay of each net on paths in the circuit is determined and nets on paths whose path delay is larger than a predetermined threshold are thus determined. For example, the threshold may be (1−σ)T, where T is a critical path delay and σ<1. Rewiring is carried out on the circuit at step 1142 and an updated netlist is formed after a few rewiring transformations. Then, the updated netlist is rerouted with the channel width W at step 1143 and the final improved placement and routing results are thus generated.

A rewiring system 1200 for performing the rewiring method is also provided in the present application.

In particular, as shown in FIG. 12, the system 1200 comprises an identifying unit 1202, a checking unit 1204, a filtering unit 1206, an estimating unit 1208, and a replacing unit 1210.

The identifying unit 1202 is configured to identify candidate alternative wires for a target net of a circuit without disturbing original placement of a circuit in an FPGA. The checking unit 1204 is used to check mapping depths of the circuit when each of the identified candidates is added into the circuit, and accept the candidate wires which will not make the mapping depth increase. The filtering unit 1206 operates to filter on the accepted candidate wires so as to reserve those whose length satisfies a length constraint. The estimating unit 1208 is used to estimate wire replacing costs of the reserved candidates to select the alternative wires that can best improve FPGA delay performance. The replacing unit 1210 is configured to replace the target wire with the selected alternative wire.

In an embodiment, the rewiring system is, for example, integrated with the best known excellent Timing-driven Versatile Place and Route (TVPR) FPGA placement and routing tool. TVPR applies the simulated annealing (SA) algorithm. By continuously trying on different routing paths, the tool is able to yield high-quality routing results stably. In this case, TVPR is used as an initial placement and routing tool and then the FPGA rewiring system of the present application is applied for further improvements. None the less, the rewiring system of the present application can be integrated with any LUT-based FPGA router for result improvements. According to the rewiring method and rewiring system provided in the present application, CPU overhead is minimized and chip area penalty is avoided.

Experiments are conducted on the MCNC benchmark circuits to evaluate the efficiency of the rewiring techniques in postlayout logic perturbation for FPGA routings. In the experiments, the rewiring system is implemented in C language. The experimental platform is a 3.2 GHz Linux machine with 1 GB memory. The timing-driven routing algorithm is chosen. In addition, α=3 is set in equation (1), which gives the best quality results. All the circuits are mapped using 4-input LUTs. Each CLB contains one LUT.

Table II shows the experimental results in rewiring ability, channel width, critical path delay, and CPU time. Columns 2-4 show that 3% of all nets are replaced by their alternative wires for delay performance improvement. Although rewiring can find much more alternative wires, only a small part of them are useful in delay reduction. Columns 8-10 are about the comparison results of critical path delay. Meanwhile, the comparison results of channel width are included in Columns 5-7. The channel width of C1908 is reduced by one after seven transformations, which is not included in delay comparison because the delay of a circuit is very likely increased if the circuit is routed with a smaller channel width. The average delay reduction is nearly 11% with the highest of 32%. In Columns 11-13, it is shown that the CPU time consumed by the system is only 5% of the total time for TVPR's placement and routing, which is much faster than all other known approaches. All the benchmark circuits can be placed and routed within 3 minutes. Because starting points in the experiments are different from those used in the published work of SPFD, comparisons therebetween cannot conducted directly.

TABLE II
EXPERIMENTAL RESULTS IN REWIRING ABILITY, CHANNEL WIDTH, CRITICAL PATH DELAY,
AND CPU TIME (K = 4)

| | | | Ratio | Channel Width | | | Critical Path Delay (e−08 s) | | | CPU Time (s) | | |
|---|---|---|---|---|---|---|---|---|---|---|---|---|
| Circuit | #Trans. | #Nets | % | TVPR | RVPR | Red. (%) | TVPR | RVPR | Red. (%) | RVPR | TVPR | Ratio |
| 5xp1 | 2 | 43 | 4.65 | 4 | 4 | 0 | 2.49 | 1.70 | 31.74 | 0.12 | 1.31 | 0.09 |
| C1355 | 0 | 121 | 0 | 6 | 6 | 0 | 3.41 | 3.41 | 0 | 0.07 | 10.03 | 0.07 |
| C1908 | 7 | 166 | 4.22 | 7 | 6 | 14.29 | 4.99 | 5.59 | — | 0.41 | 6.56 | 0.06 |
| C6288 | 0 | 1011 | 0 | 5 | 5 | 0 | 14.22 | 14.22 | 0 | 0.98 | 139.90 | 0.01 |
| C880 | 6 | 180 | 3.33 | 6 | 6 | 0 | 4.11 | 3.48 | 15.33 | 0.19 | 13.81 | 0.01 |
| alu2 | 18 | 168 | 10.71 | 6 | 6 | 0 | 5.00 | 4.79 | 4.15 | 2.59 | 30.65 | 0.08 |
| apex6 | 0 | 375 | 0 | 5 | 5 | 0 | 3.97 | 3.97 | 0 | 2.33 | 101.65 | 0.02 |
| comp | 2 | 64 | 3.13 | 3 | 3 | 0 | 3.06 | 2.47 | 19.37 | 0.03 | 1.30 | 0.02 |
| duke2 | 6 | 175 | 3.43 | 6 | 6 | 0 | 3.77 | 3.30 | 12.57 | 1.87 | 25.18 | 0.07 |
| f51m | 1 | 50 | 2.00 | 4 | 4 | 0 | 2.17 | 1.93 | 11.06 | 0.20 | 1.60 | 0.12 |
| pcler8 | 0 | 65 | 0 | 4 | 4 | 0 | 1.87 | 1.87 | 0 | 0.02 | 1.34 | 0.01 |
| term1 | 11 | 104 | 10.58 | 5 | 5 | 0 | 2.29 | 1.99 | 12.91 | 0.24 | 4.74 | 0.05 |
| ttt2 | 7 | 88 | 7.95 | 4 | 4 | 0 | 2.49 | 1.81 | 27.11 | 0.14 | 3.44 | 0.04 |
| x3 | 6 | 378 | 1.59 | 5 | 5 | 0 | 3.80 | 3.68 | 3.10 | 1.62 | 71.20 | 0.02 |
| Average | | | 3.69 | | | 1.02 | | | 10.56 | | | 0.05 |

Trans.: Transformations
RVPR: TVPR with the rewiring system
Red.: Reduction

In the invention application, an efficient and effective postlayout logic perturbation scheme is proposed to further improve upon already excellent FPGA performance. The rewiring system is implemented and integrated with TVPR. Based on the relation between a circuit's logic structure and physical layout, a set of rules for alternative candidate identifications and a series of strategies for candidate selections are proposed. According to the experimental results, it shows that among all the alternative wires found by the rewiring system, only a small subset of them are truly useful for FPGA delay performance improvement. Compared to other previous similar works relying on more randomized rewiring schemes, the scheme of the present application outperforms in its better-planned, very low overhead and significant improvement. Compared with TVPR's high-quality results, the method of the present application can still achieve a critical path delay reduction of up to 31.74% for some circuits without placement disturbance or area penalty. The CPU time consumed by the rewiring system is only 5% of the total time used by TVPR's placement and routing, which makes this scheme an excellent and practical choice even for large circuits. All benchmark circuits can be placed and routed within 3 minutes, which is much faster than the SPFD approach. It is also demonstrated that judicious selections on rewiring steps is crucial since though nearly 30% of the total nets possess alternative wires, based on experiments conducted on FPGAs, only 3% of all nets can be replaced to yield delay performance improvements. A set of rules are also identified to maintain placement intact during these rewiring transformations. Besides producing excellent FPGA postlayout delay performance improvement upon TVPR, this is also the first work showing the improvement room for wiring-targeted logic synthesis directly linked with the underlined FPGA physical layout context.

Thus, a novel method and system for FPGA rewiring has been described. It will be evident that various modifications and changes may be made thereto without departing from the broader spirit and scope of the invention as set forth in the appended claims. The specification and drawings are, accordingly, to be regarded in an illustrative sense rather than a restrictive sense.

What is claimed is:

1. A method for improving FPGA routings of a circuit, comprising:
identifying alternative wires for a target wire to be replaced in the circuit according to a first preset rule;
selecting a first set of alternative wires from the identified candidate alternative wires according to a second preset rule;
filtering the selected first set of candidate alternative wires so as to reserve a second set of candidates;
estimating wire replacing costs of the second set of candidate alternative wires to select a third set of candidates that can improve FPGA delay performance of the circuit; and
replacing the target wire with the selected third set of candidate alternative wires.

2. The method according to claim 1, wherein the first preset rule is set such that an original FPGA placement of the circuit is not disturbed when each of alternative wires identified according to the first preset rule is added into the circuit.

3. The method according to claim 1, wherein the second preset rule is set such that each of the first set of candidates is selected so as not to make each of the mapping depths of a circuit increase when each of the identified alternative wires is added into the circuit.

4. The method according to claim 1, wherein each of the candidate alternative wires in the second set is reserved such that a mapping depth thereof satisfies a length constraint.

5. The method according to claim 4, wherein the length constraint is:
LEN(AW)≦LEN(TW)+α,
wherein LEN(AW) and LEN(TW) represent lengths of the second set of candidate alternative wires and the target wire, respectively, and α is an integer specified by users.

6. The method according to claim 5, wherein α is 3.

7. The method according to claim 1, wherein the wire replacing costs are calculated by:
$$Cost = {\sum }_{i = 1}^{{N}_{nets}} q ( i ) [ \frac{{bb}_{x} ( i )}{{{C}_{av , x} ( i )}^{β}} + \frac{{bb}_{y} ( i )}{{{C}_{av , y} ( i )}^{β}} ]$$
wherein Nₙₑₜₛ is the total number of the nets, bbₓ(i) and bb_{y}(i) denote horizontal and vertical spans of net i's bounding box, respectively, C_{av,x}(i) and C_{av,y}(i) indicate an average channel capacity in horizontal and vertical directions over the bounding box of net i, respectively, β is used to adjust a relative cost of using narrow and wide channels, and q(i) is used to approximate routing resource demands inside the bounding box and represents a net weight.

8. The method according to claim 7, wherein β is 1.

9. The method according to claim 1, wherein the target wire is a wire on a path in the circuit, whose delay is larger than a predetermined threshold.

10. The method according to claim 9, wherein the predetermined threshold is (1−σ)T, wherein T is a critical path delay and σ<1.

11. A system for improving FPGA routings in a circuit, comprising:
an identifying unit configured to identify candidate alternative wires for a target wire in the circuit according to a first preset rule;
a checking unit configured to check the identified alternative wires so as to select a first set of alternative wires from the candidates according to a second preset rule;
a filtering unit configured to filter on the selected first set of candidate alternative wires so as to reserve a second set of candidates;
an estimating unit configured to estimate wire replacing costs of the reserved second set of candidate alternative wires to select a third set of candidates that can improve FPGA delay performance of the circuit; and
a replacing unit configured to replace the target wire with the selected third set of candidates.

12. The system according to claim 11, wherein the first preset rule is set such that an original FPGA placement of the circuit is not disturbed when each of alternative wires identified according to the first preset rule is added into the circuit.

13. The system according to claim 11, wherein the second preset rule is set such that each of the first set of candidates is selected so as not to make each of the mapping depths of the circuit increase when each of the identified alternative wires is added into the circuit.

14. The system according to claim 11, wherein each of the second set of alternative wires is reserved such that a mapping depth thereof satisfies a length constraint.

15. The system according to claim 14, wherein the length constraint is:
LEN(AW)≦LEN(TW)+α,
wherein LEN(AW) and LEN(TW) represent lengths of the second set of alternative wires and the target wire, respectively, and α is an integer specified by users.

16. The system according to claim 15, wherein α is 3.

17. The system according to claim 11, wherein the wire replacing costs are calculated by:
$$Cost = {\sum }_{i = 1}^{{N}_{nets}} q ( i ) [ \frac{{bb}_{x} ( i )}{{{C}_{av , x} ( i )}^{β}} + \frac{{bb}_{y} ( i )}{{{C}_{av , y} ( i )}^{β}} ]$$
wherein Nₙₑₜₛ is the total number of the nets, bbₓ(i) and bb_{y}(i) denote horizontal and vertical spans of net i's bounding box, respectively, C_{av,x}(i) and C_{av,y}(i) indicate an average channel capacity in horizontal and vertical directions over the bounding box of net i, respectively, β is used to adjust a relative cost of using narrow and wide channels, and q(i) is used to approximate routing resource demands inside the bounding box and represents a net weight.

18. The system according to claim 17, wherein β is 1.

19. The system according to claim 11, wherein the target wire is a wire on a path in the circuit, whose delay is larger than a predetermined threshold.

20. The system according to claim 19, wherein the predetermined threshold is (1−σ)T, wherein T is a critical path delay and σ<1.

21. A system for improving FPGA routings in a circuit, comprising:
means for identifying candidate alternative wires for a target wire in the circuit according to a first preset rule;
means for checking the identified alternative wires so as to select a first set of alternative wires from the candidates according to a second preset rule;
means for filtering the selected first set of candidate alternative wires so as to reserve a second set of candidates;
means for estimating wire replacing costs of the reserved second set of candidate alternative wires to select a third set of candidates that can improve FPGA delay performance of the circuit; and
means for replacing the target wire with the selected third set of candidates.

22. The system according to claim 21, wherein the first preset rule is set such that an original FPGA placement of the circuit is not disturbed when each of alternative wires identified according to the first preset rule is added into the circuit.

23. The system according to claim 21, wherein the second preset rule is set such that each of the first set of candidates is selected so as not to make each of the mapping depths of the circuit increase when each of the identified alternative wires is added into the circuit.

24. The system according to claim 21, wherein each of the second set of alternative wires is reserved such that a mapping depth thereof satisfies a length constraint.

25. The system according to claim 24, wherein the length constraint is:
LEN(AW)≦LEN(TW)+α,
wherein LEN(AW) and LEN(TW) represent lengths of the second set of alternative wires and the target wire, respectively, and α is an integer specified by users.

26. The system according to claim 25, wherein α is 3.

27. The system according to claim 21, wherein the wire replacing costs are calculated by:
$$Cost = {\sum }_{i = 1}^{{N}_{nets}} q ( i ) [ \frac{{bb}_{x} ( i )}{{{C}_{av , x} ( i )}^{β}} + \frac{{bb}_{y} ( i )}{{{C}_{av , y} ( i )}^{β}} ]$$
wherein Nₙₑₜₛ is the total number of the nets, bbₓ(i) and bb_{y}(i) denote horizontal and vertical spans of net i's bounding box, respectively, C_{av,x}(i) and C_{av,y}(i) indicate an average channel capacity in horizontal and vertical directions over the bounding box of net i, respectively, β is used to adjust a relative cost of using narrow and wide channels, and q(i) is used to approximate routing resource demands inside the bounding box and represents a net weight.

28. The system according to claim 27, wherein β is 1.

29. The system according to claim 21, wherein the target wire is a wire on a path in the circuit, whose delay is larger than a predetermined threshold.

30. The system according to claim 29, wherein the predetermined threshold is (1−σ)T, wherein T is a critical path delay and σ<1.
